(19) United States
(12) Patent Application Publication
(10) Pub. No.: US 2006/0069930 A1
(43) Pub. Date: Mar. 30, 2006

(54) Bus architecture with reduced power mode during an access time

(75) Inventors: Robert William Dixon, Longmont, CO (US); Anthony L. Priborsky, Lyons, CO (US)

Correspondence Address: SEAGATE TECHNOLOGY LLC C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Seagate Technology LLC, Scotts Valley, CA (US)

(21) Appl. No.: 10/955,855

(22) Filed: Sep. 30, 2004

(51) Int. Cl. G06F 1/30

(52) U.S. Cl. 713/300

(57) ABSTRACT

A circuit includes a bus architecture with an active mode and a reduced power mode. A host system provides a request for device data to the bus architecture and a device receives the request during the active mode. The device provides the device data after a device access time. The bus architecture operates in the reduced power mode during the device access time.

### FIELD OF THE INVENTION

The present invention relates generally to communication over bus architectures, and more particularly but not by limitation to reducing power consumption by such bus architectures.

### BACKGROUND OF THE INVENTION

In a computer system, disc drives and other data storage devices are connected to a computer by an attachment bus. These attachment buses operate using various standard attachment bus protocols known at IDE, ATA, SATA, VESA, MCA. The computer requests data that is stored in a storage device, and the storage device provides the data after an access time. During the access time, the bus is actively powered, waiting to receive transmission of the requested data. During this extended access time, the bus architecture is consuming power during an idle interval when no useful transmissions are passing over the bus.

As power consumption is reduced in other computer circuits, the power wasted by the bus during the idle access time becomes a larger proportion of total computer power consumption. Bus power consumption has become a barrier to reducing overall computer power consumption and extending battery life for portable computers.

Embodiments of the present invention provide solutions to these and other problems, and offer other advantages over the prior art.

### SUMMARY OF THE INVENTION

Disclosed is a circuit comprising a bus architecture. The bus architecture has an active mode and a reduced power mode.

A host system provides a first transmission of a request for device data to the bus architecture in the active mode. A device receives the request for device data from the bus architecture. The device provides a second transmission of device data to the bus architecture in the active mode after a device access time. The bus architecture operates in the reduced power mode during the device access time between the first and second transmissions.

Other features and benefits that characterize embodiments of the present invention will be apparent upon reading the following detailed description and review of the associated drawings.

### BRIEF DESCRIPTION OF THE DRAWINGS

FIG. 1 is an oblique view of a disc drive.

FIG. 2 illustrates a block diagram of a circuit in which a host communicates with a device by way of a bus architecture.

FIG. 3 illustrates a timing diagram of levels of energization in a circuit such as the circuit in FIG. 2.

FIG. 4 illustrates an exemplary bus architecture coupling transmissions between a host and a device.

FIG. 5 illustrates an exemplary timing diagram for the circuitry in FIG. 4.

FIG. 6 illustrates a circuit that includes a host system coupled to a data storage device by way of a serial advanced technology attachment (serial ATA, SATA) bus architecture.

FIG. 7 illustrates an example of a SATA bus architecture connected to a host and a device.

### DETAILED DESCRIPTION OF ILLUSTRATIVE EMBODIMENTS

In the embodiments described below, a bus architecture transmits or communicates requests for device data from a host, and also communicates the device data from a device after a device access time. The bus architecture includes a bus and bus circuits that are switched between an active power mode and a reduced power mode. During the device access time, when the bus architecture is idle and not carrying any useful transmissions, the bus architecture senses the inactivity on the bus and switches to the inactive mode, reducing power consumption. When the device begins sending device data after the device-access time, the bus architecture switches back to the active mode and rapidly transmits the data. The power consumption of the bus is reduced without significant speed reduction. The arrangement is particularly useful in combination with the serial ATA (SATA) bus protocol, and can utilize one of more levels of power reduction in the SATA bus protocol. “ATA” refers to the Advanced Technology Attachment protocol. The SATA bus protocol includes multiple reduced power modes. The device can select one of the multiple reduced power modes as a function of the access time, which can vary depending on what data is accessed. When access time is longer, a lower reduced power mode can be selected that has a longer response time. When access time is longer, a higher power reduced power mode can be selected that has a shorter response time.

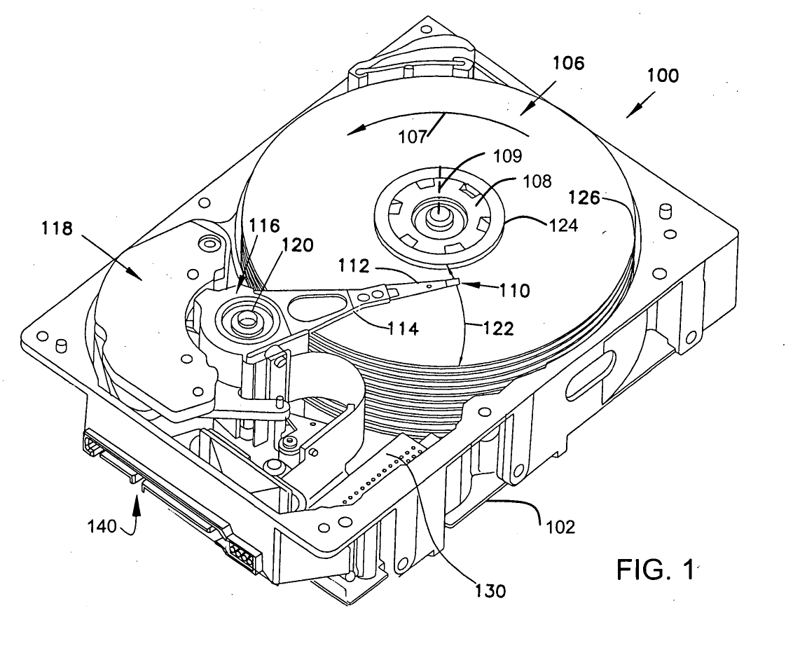

FIG. 1 is an oblique view of a disc drive 100 in which embodiments of the present invention are useful. Disc drive 100 includes a housing with a base 102 and a top cover (not shown). Disc drive 100 further includes a disc pack 106, which is mounted on a spindle motor (not shown) by a disc clamp 108. Disc pack 106 includes one or more individual discs, which are mounted for co-rotation about central axis 109 in a direction 107. Each disc surface has an associated disc head slider 110 which is mounted to disc drive 100 for communication with the disc surface. In the example shown in FIG. 1, sliders 110 are supported by suspensions 112 which are in turn attached to track accessing arms 114 of an actuator 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by electronics 130 based on signals generated by heads 110 and a host computer (not shown). Electronics 130 also includes bus circuits (not illustrated in FIG. 1) for connecting the disc drive 100 to the host computer via a SATA bus connector 140. The SATA bus connector 140 can include electrical contact pins as illustrated, or a combination of electrical contact pins and fiber optics.

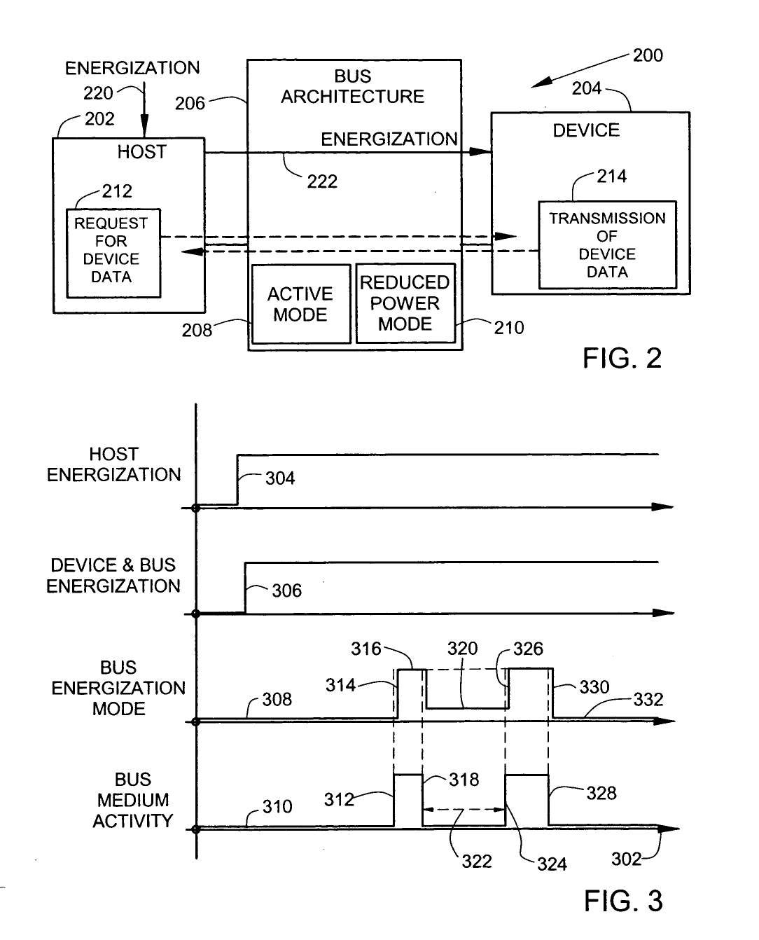

FIG. 2 illustrates a block diagram of a circuit 200 that comprises a host 202 communicating with a device 204 by way of a bus architecture 206. The host 202 is preferably a computer or computer system.

The device 204 is preferably a device that stores device data that is selectively accessed or read from time to time by the host 202. The device 202 can be a disc drive or other data storage device that requires a wait time or access time in order to reconfigure itself to provide particular selected device data requested by the host 202. In the case of a disc drive, the reconfiguration comprises repositioning and settling a read/write head over a data track which stores the particular data that is selected.

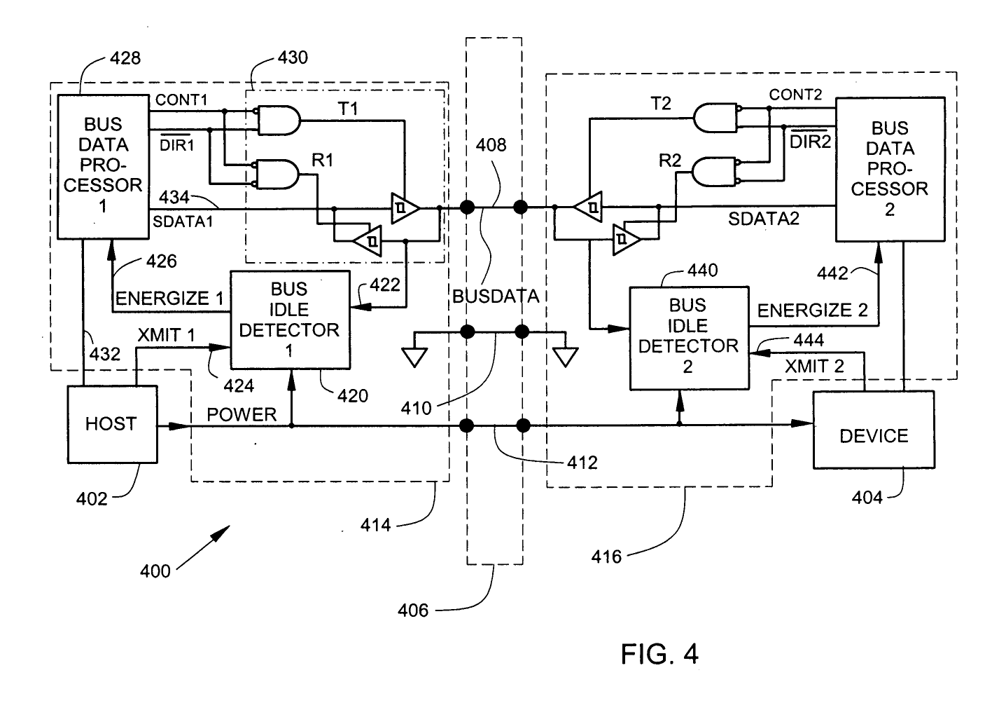

The bus architecture 206 comprises a bus medium such as a cable, bus or fiber optic, and associated connectors. The bus architecture also comprises bus circuitry that requires energization and that is directly connected to the bus medium for transmitting and receiving data on the bus medium. The bus architecture 206 is explained in more detail below by way of an example illustrated in FIG. 4.

The bus architecture 206 has an active mode 208 and at least one reduced power mode 210. The host system 202 provides a first transmission of a request for device data 212 to the bus architecture 206 in the active mode 208. The device 204 receives the request for device data 212 from the bus architecture 206. A device access time (described in more detail below in connection with an example in FIG. 3) elapses after the request for device data 212. The device 204 provides a second transmission of device data 214 to the bus in the active mode 208 after the device access time. The bus architecture 206 operates in the reduced power mode 210 during the device access time between the first transmission of the request for device data 212 and the second transmission of device data 214.

A power supply circuit (not illustrated) provides energization 220 to the host 202. The host 202 provides energization 222 to the device 204 and the bus architecture 206. The portion of energization 222 that is provided to the bus architecture 206 varies depending on whether bus architecture 206 is in the active mode 208 or a reduced power mode 210. Timing of the transmission of the request for device data 212, the access time, and the transmission of device data 214 are described in more detail below by way of an exemplary timing diagram in FIG. 3.

FIG. 3 illustrates a timing diagram of levels of energization in a circuit such as circuit 200 in FIG. 2. A horizontal axis 302 represents time. As illustrated at level transition 304, energization (such as energization 220 in FIG. 2) is applied to a host. The host, in turn, applies energization (such as energization 222 in FIG. 2) to a bus architecture (such as bus architecture 206 in FIG. 2) and a device (such as device 204 in FIG. 2) as illustrated at level transition 306.

A bus energization mode remains at a low energization level 308 when there is no transmission activity on a bus medium. At activity transition 312, The host initiates a request for data service. At level transition 314, the bus energization mode increases to a higher energization level 316 associated with an active mode (such as active mode 208 in FIG. 2). The bus architecture, operating in an active mode, rapidly transmits the request for data service to the device. After the request for data service is complete at 318, the bus energization mode drops down to a reduced power mode 320 during an access time 322 for the device. At the end of the access time 322, the device responds at activity transition 324 with a transmission of device data back to the host. The device energization mode makes a level transition 326 back to the active mode and the device data is rapidly transmitted to the host. After the transmission of device data is complete at activity transition 328, the bus energization mode makes a level transition 330 back to a reduced power mode. In a preferred arrangement, the reduced power level 320 is different than the reduced power levels 308, 332.

FIG. 4 illustrates an exemplary bus architecture 400 coupling transmissions between a host 402 and a device 404. The bus architecture 400 comprises a bus (also called a communication medium) 406. The bus 406 comprises a conductor 408 that carries bus communications (BUSDATA), a common or return conductor 410 and a power conductor 412 that couples energization from the host 402 to the device 404.

The bus architecture 400 comprises circuitry 414 that interfaces the host 402 with the bus 406. The circuitry 414 is typically physically co-located with circuitry of the host 402 in a host assembly or housing (not illustrated) such as a computer. The bus architecture 400 further comprises circuitry 416 that interfaces the device 404 with the bus 406. The circuitry 416 is typically co-located with circuitry of the device 404 in a device assembly or housing. (not illustrated). The device assembly or housing may be internal to the host assembly or housing, or may alternatively be external to the host assembly or housing. The circuitry 414, 416 provides physical layer interfacing with the bus 406. The circuitry 414, 416 also typically includes data link layer, network layer, transport layer and session layer aspects of a serial communication protocol used for communication over the bus 406.

The circuitry 416 has essentially identical components and topology as the circuit 414. Circuit 414 is described below as interfacing the host 402 to the bus 406, and it will be understood that circuit 416 operates in essentially the same way in interfacing the device 404 to the bus 406. Circuitry 414 is described in detail relative to interfacing the host 402 to the bus and it will be understood that this description also applies to the operation of the circuitry 416 in interfacing the device 404 to the bus 406.

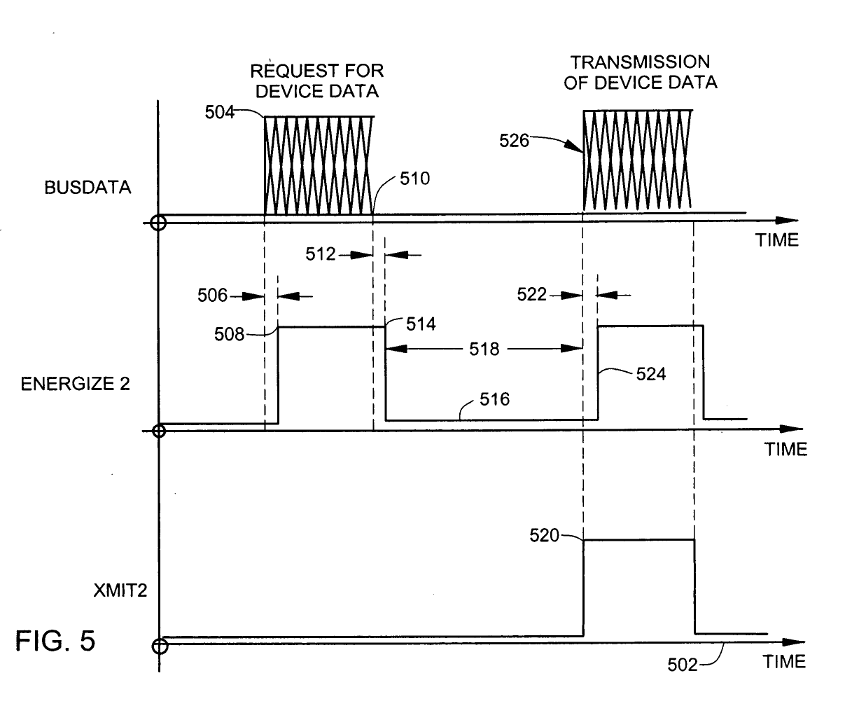

The circuit 414 comprises a bus idle detector circuit 420 that has a bus input 422 that senses activity (level transitions) on bus conductor 408 and that also has an XMIT input 424 that senses transmission activity received from the host 402. If the bus idle detector 420 does not sense activity on either input 422 or 424, then the bus idle detector senses the existence of an idle condition and switches an energize output 426 to a reduced power consumption level. On the other hand, if the bus idle detector 420 senses activity on either input 422 or 424, then the bus idle detector senses an active condition and switches the energize output 426 to a higher power consumption level. The bus idle detector 422 has a response time between sensing activity and switching the energization output 426. The response time of the bus idle detector is shorter than an access time of the device 404 such that the circuit 414 reduces power during the access time to conserve power. The response time is explained in more detail below by way of an example illustrated in FIG. 5.

The energize output couples to a bus data processor 428. The bus data processor 428 provides processing of bus layer protocols that can include data link layer, network layer, transport layer and session layer aspects of a serial communication protocol. The bus data processor 428 provides an output/DIR that controls direction of operation of a bus transceiver 430. The bus data processor 428 also provides a control output CONT that controls energization of the bus transceiver 430. The control output CONT shuts off energization of the bus transceiver 430 when the energize output 426 is off. For conserving power in the reduced power mode, the bus data processor 428 can shut off blocks of circuitry with bus layer protocol processing functions that are not needed. The bus data processor can also switch to a lower clock speed to reduce power consumption in the reduced power mode.

The bus data processor 428 exchanges data with the host 402 on line 432. The bus data processor 428 exchanges data SDATA with the bus transceiver 430 on line 434.

FIG. 5 illustrates an exemplary timing diagram for the circuitry 416 in FIG. 4. A horizontal axis 502 represents time. At the beginning of the timing diagram, the host 402 provides a request for device data (not illustrated in FIG. 5) on line 432 to the circuitry 414. The circuitry 414 applies layers of a bus communication protocol (as described above in connection with FIG. 4) and provides the request for device data in the form of BUSDATA starting at time 504 in FIG. 5. After a response time 506, a bus idle detector 440 (FIG. 4) detects the BUSDATA 504 and switches an energize output 442 (FIG. 4) to a higher level at time 508. The request for device data in the form of BUSDATA ends at time 510. After a response time 512, the energize output 442 switches to a lower energization level at time 514. The energize output remains at a reduced power level (reduced power mode) at 516 during a device access time 518. At the end 520 of the bus access time, the device 404 is ready to provide a transmission of device data. The device 404 (FIG. 4) turns on an XMIT input 444 (FIG. 4) on the bus idle detector 440 (FIG. 4) at time 520. After a response time 522, the energize output 442 switches to a higher level again at time 524 and device data 526 is transmitted to the host 402 by way of the circuit 414.

The response times 506, 512 and 522 are short in comparison to the access time 518. In a preferred arrangement, the response time 512 is no more than 5% of the access time 518. During most of the access time, the bus 400 (FIG. 4) is in a reduced power mode which reduces energy consumption by the bus 400 between the request for device data and the transmission of device data.

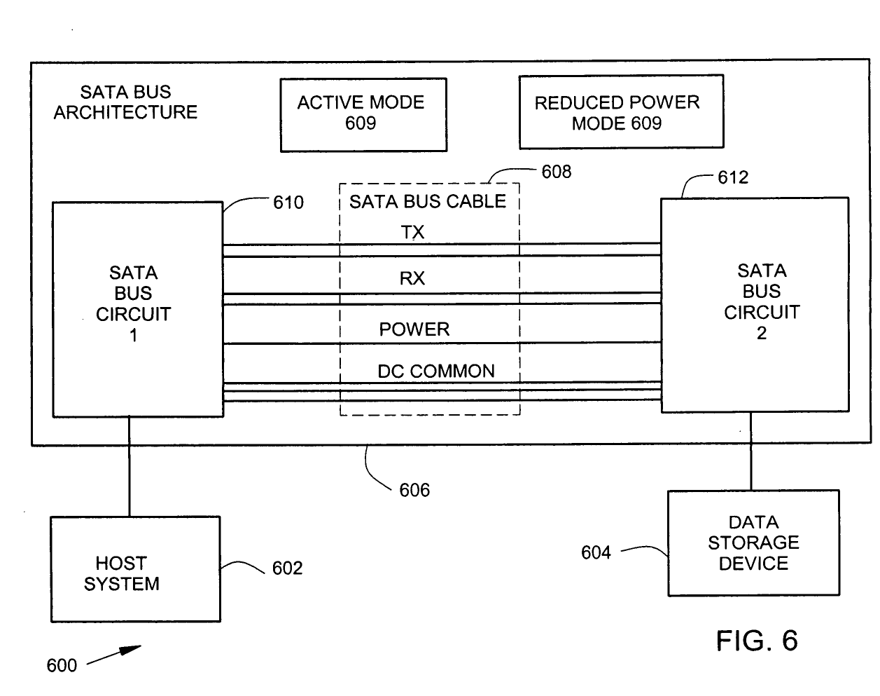

FIG. 6 illustrates a circuit 600 that includes a host system 602 coupled to a data storage device 604 by way of a serial advanced technology attachment (serial ATA, SATA) bus architecture 606. The host system 602 is preferably a computer or computer system.

The data storage device 604 is preferably a hard disc drive that requires a wait time or access time in order to seek and retrieve data requested by the host 602. The SATA bus architecture 606 comprises a SATA bus cable 608 and associated connectors (such as connector 140 in FIG. 1, for example). The SATA bus cable 608 is typically enhanced to include power supply connectors for the data stage device 604. The bus architecture also comprises bus circuitry 610, 612 that requires energization and that is directly connected to the bus cable 608 for transmitting and receiving data on the bus cable 608. The arrangement shown in FIG. 6 is generally similar to the arrangement shown in FIG. 2, however the SATA bus is enhanced to include separate differential balanced RX and TX line pairs for high speed communication, rather than transmitting in both directions over a single unbalanced (“single ended”) conductor referenced to common.

The SATA bus architecture 606 has an active mode 609 and at least one reduced power mode 611. The host system 602 provides a first transmission of a request for device data to the SATA bus architecture 606 in the active mode 609. The device 604 receives the request for device data from the SATA bus architecture 606. A device access time elapses after the request for device data. The device 604 provides a second transmission of device data to the SATA bus architecture 606 in the active mode after the device access time. The SATA bus architecture 606 operates in the reduced power mode during the device access time between the first transmission of the request for device data and the second transmission of device data.

The SATA bus architecture 606 and the bus 608 have an active mode and at least one reduced power mode. The host system 602 transmits a request to the SATA bus architecture 606 in the active mode for data stored in the data storage device 604. The data storage device 604 provides a transmission of the stored data to the SATA bus architecture 606 in the active mode after an access time of the data storage device 604. The SATA bus architecture 606 operates in the reduced power mode during the access time.

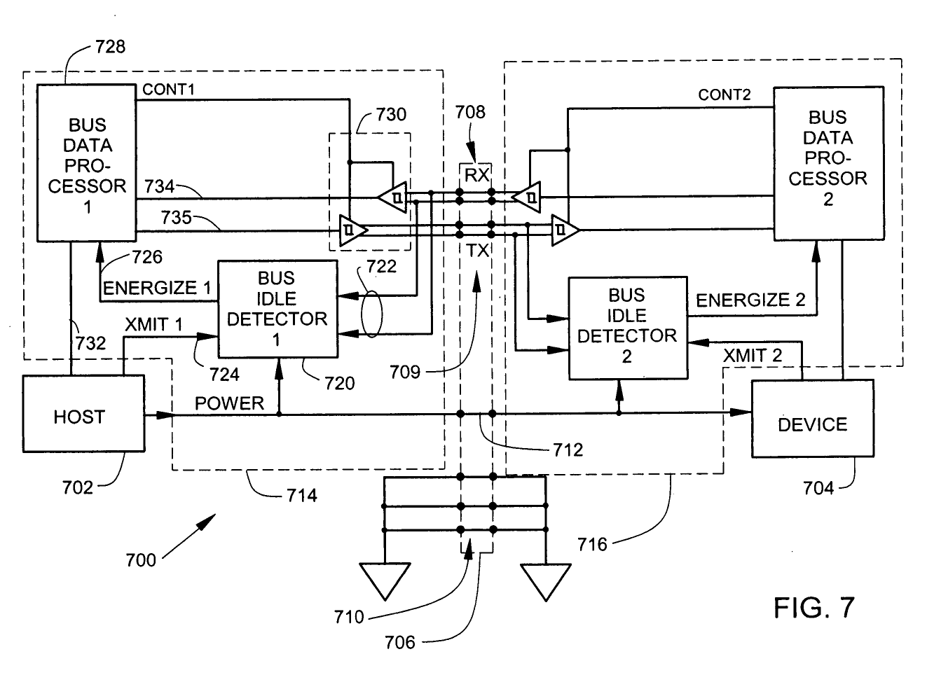

Switching of the SATA bus architecture 606 between active and reduced power modes can be performed, for example, generally as described above in connection with FIGS. 2-3. The SATA bus 608 transitions from operating in the active mode to operating in the reduced power mode during the access time. The SATA bus architecture 606 transitions from operating in the reduced power mode to operating in the active mode during the access time. The reduced power mode is preferably either a partial mode of a serial ATA bus or a slumber mode of a serial ATA bus protocol. The SATA bus architecture 606 is explained in more detail below by way of an examples illustrated in FIG. 7.

FIG. 7 illustrates an example of a SATA bus architecture 700 connected to a host 702 and a device 704. The bus architecture 700 comprises a SATA bus (also called a SATA communication medium) 706. The bus 706 comprises conductor pairs RX (708) and TX (709) that carry SATA bus communications, common or return conductors 710 and a power conductor 712 that couples energization from the host 702 to the device 704.

The SATA bus architecture 700 comprises circuitry 714 that interfaces the host 702 with the SATA bus 706. The circuitry 714 is typically physically co-located with circuitry of the host 702 in a host assembly or housing (not illustrated) such as a computer. The SATA bus architecture 700 further comprises circuitry 716 that interfaces the device 704 with the SATA bus 706. The circuitry 716 is typically co-located with circuitry of the device 704 in a device assembly or housing. (not illustrated). The device assembly or housing may be internal to the host assembly or housing, or may alternatively be external to the host assembly or housing. The circuitry 714, 716 provides SATA physical layer interfacing with the SATA bus 706. The circuitry 714, 716 also typically includes data link layer, network layer, transport layer and session layer aspects of a serial communication protocol used for communication over the SATA bus 706.

The circuitry 716 has essentially identical components and topology as the circuit 714. Circuit 714 is described below as interfacing the host 702 to the SATA bus 706, and it will be understood that circuit 716 operates in essentially the same way in interfacing the device 704 to the SATA bus 706.

The circuit 714 comprises a bus idle detector circuit 720 that has a bus input pair 722 that senses activity (level transitions) on bus conductors 708 (RX) and that also has an XMIT input 724 that senses transmission activity received from the host 702. If the bus idle detector 720 does not sense activity on either input 722 or 724, then the bus idle detector senses the existence of an idle condition and switches an energize output 726 to a reduced power level. On the other hand, if the bus idle detector 720 senses activity on either input 722 or 724, then the bus idle detector senses an active condition and switches the energize output 726 to an active power level. The bus idle detector 722 has a response time between sensing activity and actuating the energization output 726. The response time of the bus idle detector 722 is shorter than an access time of the device 704 such that the circuit 714 operates at a reduced power level during the access time to conserve power.

The energize output 726 couples to a bus data processor 728. The bus data processor 728 provides processing of bus layer protocols that can include data link layer, network layer, transport layer and session layer aspects of a SATA serial communication protocol. The bus data processor 728 provides a control output CONT that controls energization of the bus transceiver 730. The control output CONT reduces energization of RX and TX bus transceiver 730 when the energize output 726 is at a reduced power level.

The bus data processor 728 exchanges data with the host 702 on line 732. The bus data processor 728 exchanges data in SATA format with the bus transceiver 730 on lines 734, 735.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular bus architecture while maintaining substantially the same functionality without departing from the scope of the present invention. The invention is adaptable for use with universal serial bus (USB) and compact flash protocols. In addition, although a preferred embodiment described herein is directed to a data storage devices for computer system, it will be appreciated by those skilled in the art that the teachings of the present invention can be applied to other devices with an access time, without departing from the scope of the present invention.

What is claimed is:

1. A circuit, comprising:
a bus architecture having an active mode and a reduced power mode;
a host system providing a first transmission of a request for device data to the bus architecture in the active mode; and
a device receiving the request for device data from the bus architecture, the device providing a second transmission of device data to the bus architecture in the active mode after a device access time, the bus architecture operating in the reduced power mode during the device access time.

2. The circuit of claim 1, wherein the host system provides power to the bus architecture.

3. The circuit of claim 2 wherein the host system provides power to the device.

4. The circuit of claim 1, wherein the bus architecture comprises:
a bus and a first bus driver coupled to the bus;
a first bus data processor coupled to the host system and to the first bus driver; and
a first bus idle detector switching the first bus data processor from the active mode to the reduced power mode.

5. The circuit of claim 4, wherein the bus architecture comprises:
a second bus driver coupled to the bus;
a second bus data processor coupled to the device and the second bus driver; and
a second bus idle detector switching the second bus data processor from the active mode to the reduced power mode.

6. The circuit of claim 1 wherein the bus architecture comprises a SATA bus architecture and the first and second transmissions comprise a SATA bus protocol.

7. A circuit, comprising:
a bus architecture having an active mode and a reduced power mode;
a host system transmitting a request for stored data to the bus architecture in the active mode; and
a data storage device providing a transmission of the stored data to the bus architecture in the active mode after a device access time, the bus architecture operating in the reduced power mode during the device access time.

8. The circuit of claim 7 wherein the bus architecture switches from operating in the active mode to operating in the reduced power mode during the device access time.

9. The circuit of claim 7 wherein the bus architecture switches from operating in the reduced power mode to operating in the active mode during the device access time.

10. The circuit of claim 7 wherein the reduced power mode is a partial mode of a serial ATA bus protocol.

11. The circuit of claim 7 wherein the reduced power mode is a slumber mode of a serial ATA bus protocol.

12. A method of reducing bus power consumption, comprising:
providing a bus architecture with an active mode and a reduced power mode;
transmitting a request for device data to the bus architecture in the active mode; and
providing the device data to the bus architecture in the active mode after a device access time, the bus operating in the reduced power mode during the device access time.

13. The method of claim 12, further comprising:
providing power to the bus architecture from a host system.

14. The method of claim 13, further comprising:
providing power from the host system to a device which provides the device data.

15. The method of claim 14, further comprising:
coupling a first bus driver to a bus in the bus architecture;
coupling a first bus data processor to the host system and the first bus driver; and
switching the first bus data processor from the active mode to the reduced power mode with a first bus idle detector.

16. The method of claim 12, further comprising:
transmitting the request and the device data formatted with a SATA bus protocol.

17. The method of claim 12, further comprising:
switching from operating in the active mode to operating in the reduced power mode during the device access time.

18. The method of claim 12, further comprising:
switching from operating in the reduced power mode to operating in the active mode during the device access time.

19. The method of claim 12 wherein the reduced power mode is a partial mode of a serial ATA bus.

20. The method of claim 12 wherein the reduced power mode is a slumber mode of a serial ATA bus.
